(19) United States
(12) Patent Application Publication
(10) Pub. No.: US 2011/0231232 A1
(43) Pub. Date: Sep. 22, 2011

(54) ELECTRONIC ADVERTISING SYSTEM

(76) Inventor: CHUN-MI CHU, Zhonghe City (TW)

(21) Appl. No.: 12/725,479

(22) Filed: Mar. 17, 2010

(51) Int. Cl. G06Q 30/00

(52) U.S. Cl. 705/14.4

(57) ABSTRACT

An electronic advertising system includes an advertising figure, and the electronic advertising system processes the advertising figure to form a first predetermined quantity of advertising blocks and repeatedly form a second predetermined quantity of advertising blocks from the first quantity of advertising blocks respectively, and the electronic advertising system provides the second predetermined quantity of advertising units, and each advertising unit has he first predetermined quantity of same advertising blocks, the first predetermined quantity of different advertising blocks, or the first predetermined quantity of partially same and partially different advertising blocks. Therefore the electronic advertising system can improve the advertising effect of the advertising figure by the plurality of advertising units.

### FIELD OF THE INVENTION

The present invention relates to an electronic advertising system, in particular to the electronic advertising system that improves the advertising effect of an advertising figure by a plurality of advertising units.

### BACKGROUND OF THE INVENTION

Products generally gain more publicity exposures by advertising, and most of the products are advertised through television, radio broadcasting, network, magazine, or billboard, so that the products can be shown in front of the public frequently. However, the aforementioned advertising methods require manufacturers to take active actions and consumers simply take passive actions. If consumers have no chance to see the advertising, the efforts and expenses of the advertising will be wasted. Furthermore, the aforementioned advertising methods require continuous playing, publication or display locations, such that the products have a better chance to be exposed extensively. Such advertising not just incurs a high cost, but also bears a high financial risk if the products are not sold very well.

Therefore, it is an important subject for related manufacturers to develop an advertising system to improve the advertising effect.

### SUMMARY OF THE INVENTION

In view of the aforementioned shortcomings of the conventional advertising system, the inventor of the present invention based on years of experience in the related industry to conduct extensive researches and experiments, and finally developed an electronic advertising system, in hope of improving the advertising effect of an advertising figure by a plurality of advertising units.

Therefore, it is a primary objective of the present invention to overcome the aforementioned shortcomings and deficiencies of the prior art by providing an electronic advertising system that processes an advertising figure to form a plurality of advertising blocks, such that an advertising unit can have a different combination of the advertising blocks to achieve the effect of improving the advertising effect of the advertising figure.

To achieve the foregoing objective, the present invention provides an electronic advertising system having an advertising figure, and the electronic advertising system processes the advertising figure to form a first predetermined quantity of advertising blocks and repeatedly form a second predetermined quantity of advertising blocks from the first quantity of advertising blocks respectively, and the electronic advertising system provides the second predetermined quantity of advertising units, and each advertising unit has the first predetermined quantity of same advertising blocks, the first predetermined quantity of different advertising blocks, or the first predetermined quantity of partially same and partially different advertising blocks. Therefore the electronic advertising system can improve the advertising effect of the advertising figure by the plurality of advertising units.

The electronic advertising system is connected to a plurality of connecting units for receiving the advertising units respectively, and the advertising blocks are transmitted among the connecting units by the electronic advertising system.

The connecting unit is a computer, a mobile phone or a personal digital assistant.

The connecting unit is connected to the electronic advertising system by a cable network, a wireless network or a voice over Internet protocol (VoIP) network.

Therefore, the electronic advertising system of the present invention can improve the advertising effect of the advertising figure by the plurality of advertising units.

### BRIEF DESCRIPTION OF THE DRAWINGS

FIG. 1 is a schematic view of an electronic advertising system in accordance with a preferred embodiment of the present invention;

FIG. 2 is a schematic view of an advertising block in accordance with a preferred embodiment of the present invention;

FIG. 3 is a schematic view of repeatedly forming advertising block in accordance with a preferred embodiment of the present invention;

FIG. 4 is a schematic view of an advertising unit in accordance with a preferred embodiment of the present invention; and

FIG. 5 is a schematic view of an electronic advertising system in accordance with another preferred embodiment of the present invention.

### DESCRIPTION OF THE PREFERRED EMBODIMENTS

The objects, characteristics and effects of this invention will become apparent with the detailed description of the preferred embodiments together with the illustration of related drawings as follows.

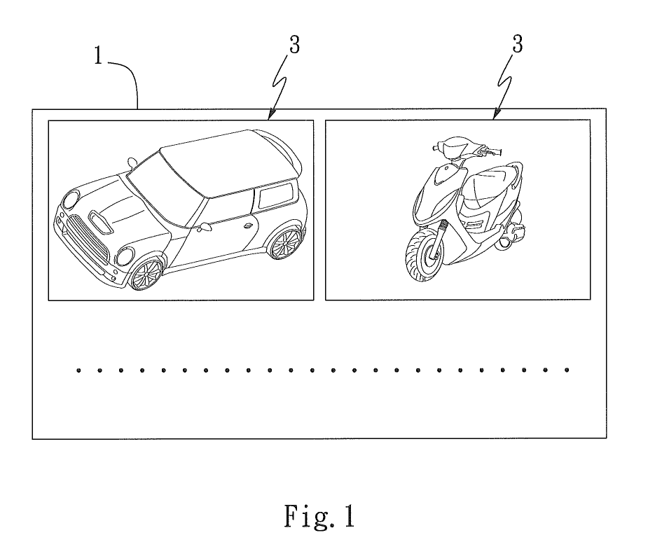

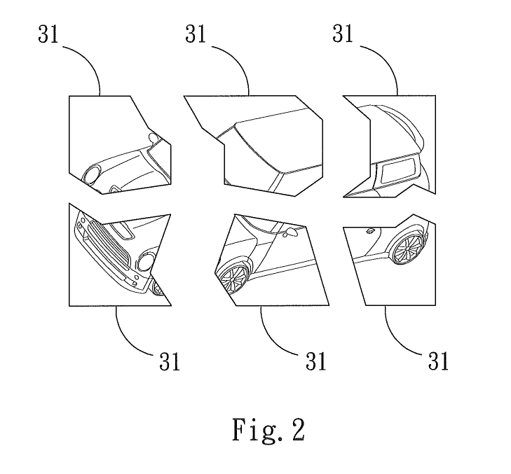

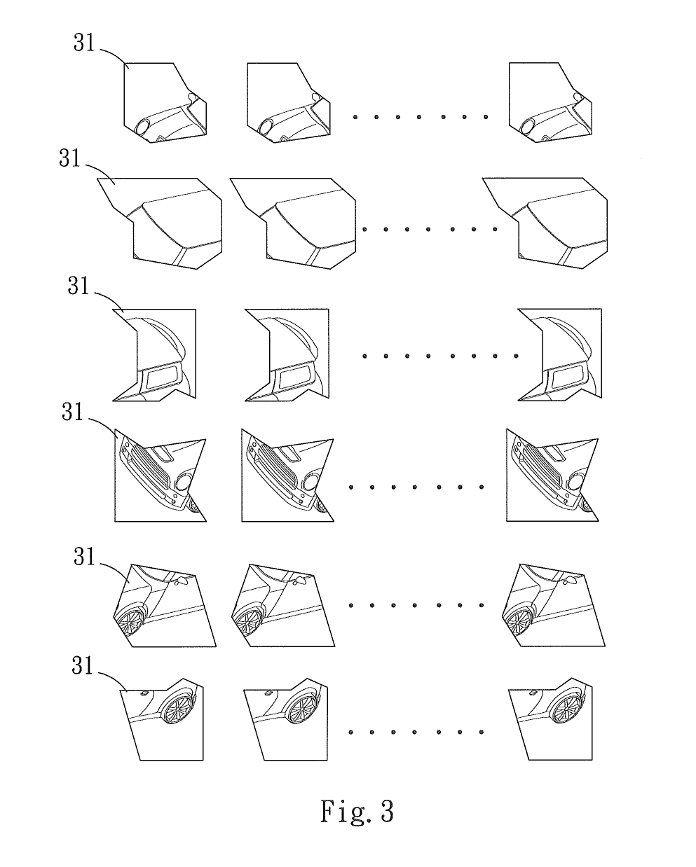

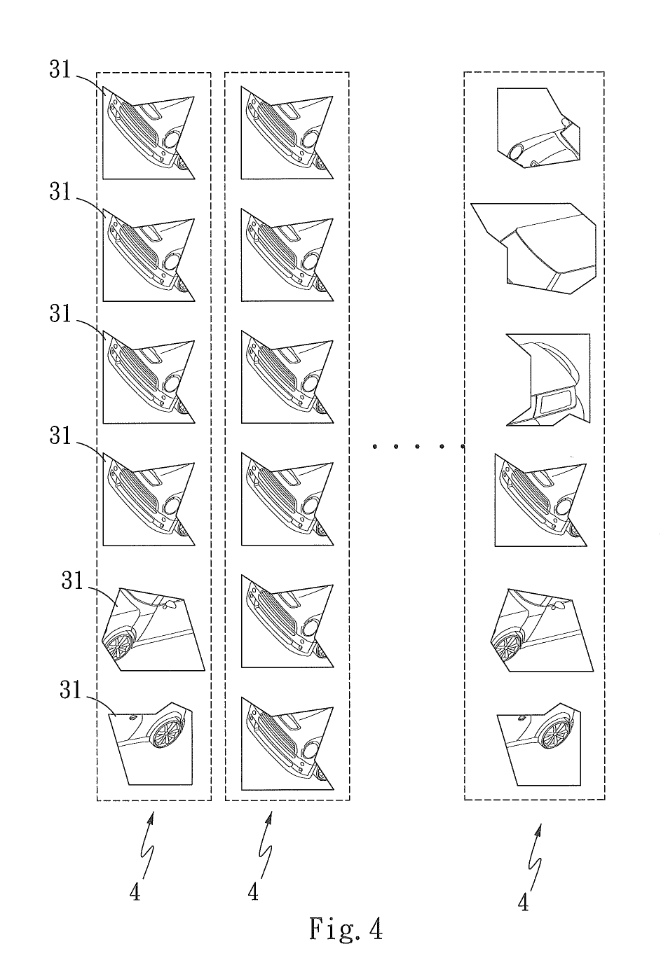

With reference to FIGS. 1 to 4 for a schematic view of an electronic advertising system, a schematic view of an advertising block, a schematic view of repeatedly forming the advertising block, and a schematic view of an advertising unit in accordance with a preferred embodiment of the present invention respectively, the electronic advertising system 1 as shown in FIG. 1 comprises an advertising FIG. 3 showing one or more products of a company or several companies and provided for a consumer's viewing and choice, such that a single system can achieve the best advertising effect. The electronic advertising system 1 processes the advertising FIG. 3 to form a first predetermined quantity of advertising blocks 31, wherein the first predetermined quantity is plural, such as six as shown in FIG. 2, and the electronic advertising system 1 repeatedly forms the advertising blocks 31 to produce a second predetermined quantity of advertising blocks 31 as shown in FIG. 3. The electronic advertising system 1 provides the second predetermined quantity of advertising units 4, and the advertising units 4 have the first predetermined quantity of same advertising blocks 31 (as indicated by the second column in FIG. 4), the first predetermined quantity of different advertising blocks 31 (as indicated by the last column of FIG. 4), or the first predetermined quantity of partially same and partially different advertising blocks 31 (as indicated by the first column in FIG. 4).

As described above, after a consumer examines various different advertising FIG. 3, the consumer selects the desired advertising FIG. 3, and then the electronic advertising system 1 provides an advertising unit 4 to the consumer, wherein the advertising unit 4 may have the first predetermined quantity of same advertising blocks 31, the first predetermined quantity of different advertising blocks 31, or the first predetermined quantity of partially same and partially different advertising blocks 31. If the consumer obtains the first predetermined quantity of different advertising blocks 31, then the consumer has a chance to resume the advertising FIG. 3 from the advertising blocks 31, and the process may arouse the interest of consumers, so that the consumers may actively view various different advertising FIG. 3, and the advertising effect of each advertising FIG. 3 can be improved. In addition, manufacturers may award the consumers who can resume the advertising FIG. 3, such as awarding the product promoted by the advertising FIG. 3 as a prize to encourage consumers to view different advertising FIG. 3, such that the advertising effect of each advertising FIG. 3 can be improved further.

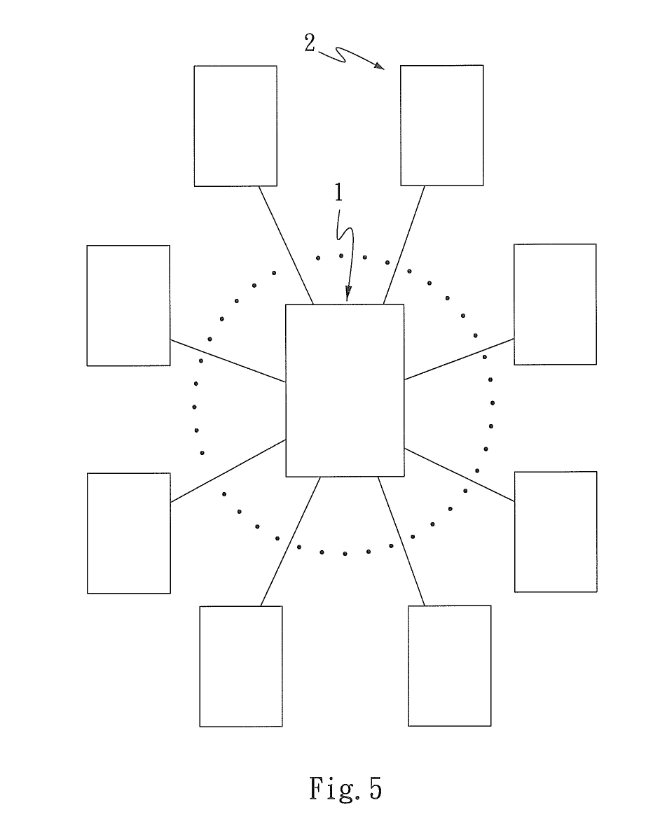

With reference to FIG. 5 for a schematic view of another preferred embodiment of the present invention together with FIGS. 1 and 4, the electronic advertising system 1 is connected to a plurality of connecting units 2 for receiving the advertising units 4 respectively, and the advertising blocks 31 are transmitted among the connecting units 2 by the electronic advertising system 1.

In another preferred embodiment of the present invention, users can connect the electronic advertising system 1 by the connecting unit 2 to achieve the foregoing objectives. In addition, if a user has an advertising unit 4 that includes the first predetermined quantity of same advertising blocks 31, the first predetermined quantity of partially same and partially different advertising blocks 31, then the connecting units 2 can be used for transmitting the advertising blocks 31 among users by the electronic advertising system 1, such that the users can exchange the advertising blocks 31, and the advertising blocks 31 can be converted back into the advertising FIG. 3. Such preferred embodiment of the present invention further expands the size of the consumer group to improve the advertising effect of each advertising FIG. 3.

The connecting unit 2 is a computer, a mobile phone or a personal digital assistant, such that consumers can connect the electronic advertising system 1 through different electronic devices such as a fixed electronic device or a portable electronic device to achieve the foregoing objectives.

The connecting units 2 are connected to the electronic advertising system 1 by a cable network, a wireless network or a VoIP network, such that a user can connect the electronic advertising system 1 in different situations, such as staying at a fixed position or moving to achieve the foregoing objectives.

In summation of the description above, the present invention processes the advertising figure to form the plurality of advertising blocks, so that the advertising unit can have a different combination of the advertising blocks to improve the advertising effect of the advertising figure, and the invention complies with patent application requirements. In addition, the products of the invention meet the market requirements, and the present invention complies with patent application requirements, and thus the invention is duly filed for patent application.

While the invention has been described by means of specific embodiments, numerous modifications and variations could be made thereto by those skilled in the art without departing from the scope and spirit of the invention set forth in the claims.

What is claimed is:

1. An electronic advertising system, having an advertising figure, and the electronic advertising system processing the advertising figure to form a first predetermined quantity of advertising blocks, and repeatedly forming a second predetermined quantity of advertising blocks from the advertising blocks respectively, and the electronic advertising system providing the second predetermined quantity of advertising units, and the advertising unit including the first predetermined quantity of same advertising blocks, the first predetermined quantity of different advertising blocks, or the first predetermined quantity of partially same and partially different advertising blocks.

2. The electronic advertising system of claim 1, further comprising a plurality of connecting units coupled to the electronic advertising system for receiving the advertising units respectively, and the advertising blocks being transmitted among the connecting units by the electronic advertising system.

3. The electronic advertising system of claim 2, wherein the connecting unit is a computer, a mobile phone or a personal digital assistant.

4. The electronic advertising system of claim 2, wherein the connecting unit is connected to the electronic advertising system by a cable network, a wireless network or a voice over Internet protocol (VoIP) network.

5. The electronic advertising system of claim 3, wherein the connecting unit is connected to the electronic advertising system by a cable network, a wireless network or a voice over Internet protocol (VoIP) network.
